(19) United States
(12) Patent Application Publication
(10) Pub. No.: US 2019/0068731 A1
(43) Pub. Date: Feb. 28, 2019

(54) NOTIFICATION SYSTEM AND METHOD

(71) Applicant: MMS USA HOLDINGS INC., Boston, MA (US)

(72) Inventor: Samuel Spicer, Munster, IN (US)

(21) Appl. No.: 15/683,364

(22) Filed: Aug. 22, 2017

(51) Int. Cl. H04L 29/08; H04L 12/18; H04W 4/06

(52) U.S. Cl. CPC H04L 67/26; H04L 12/1895; G06F 3/02; H04L 67/306; H04W 4/06

(57) ABSTRACT

A portable computing device is linked to a subscriber-based, communication service platform system. The device may be programmed with instructions and include an LCD screen, some other electronics components, and a button. When a user desires to notify a group of subscribers to an account linked to the device, the user may press the button and the device may send a message to a subscriber account of the communication service platform. The message is configurable by the user and programmed into an instruction module of the portable computing device. In some embodiments, the message may indicate the availability, location and other information related to food when used in an office environment.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In the digital age, data surrounds us. Despite ubiquity, disseminating this data can be fraught with various challenges. While composing and delivering data via email, SMS, and social media is simple, targeted data dissemination to intended recipients is difficult without precise addressing information. For example, while a single user may broadcast an electronic message or other data to numerous users, a connection to those users must be established before the data will reach them. In social media, users make connections to other users. A user may then communicate with some or all of his or her “connections” at once. A vast majority of communication through social media is completed via a graphical user interface (GUI) hosted by the particular social media network. However, these graphical user interfaces limit the type or quantity of communication a user may make via the social network. Increasingly, there is a need for other communication methods to leverage the communication power of social media without employing the network's GUI.

For example, office workers love free food. Food is often left over from catered meetings that occur in the workplace throughout the day. It is difficult, however, to inform workers of the availability of free food without broadcasting an email or intercom message to everyone in the office. Such messaging is typically not preferred in professional environments when unnecessary to the primary office function, and broadcasted messages are known to decrease productivity.

### SUMMARY

Features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

A small, portable computing device is linked to a subscriber-based, communication service platform system (e.g., Twitter). The portable computing device may include a small, open source electronics platform based on simple hardware and software (e.g., an Arduino board). The portable computing device may be programmed with instructions and include an LCD screen, some other electronics components, and a button. When food is available, a user may press the button and the device may send a message to a subscriber account of the communication service platform. The message is programmed into an instruction module of the portable computing system and indicates food availability in the office. In some embodiments, the message may also indicate the location of the food, descriptors about the food (type, amount, etc.), or other information.

In some embodiments, a portable computing device may send a notice to a plurality of subscribers. The portable computing device may comprise a first processor in functional communication with a first memory, an activation button in functional communication with the processor, a display in functional communication with the processor, and an instruction module stored in the memory and including instructions that are executable by the first processor. The instructions may cause the first processor to send an activation input from the activation button to the processor, and set a communication channel for the portable computing device in response to the activation input. The communication channel may correspond to a subscriber address of a subscriber account stored at a communication service platform that is remote from the portable computing device. The instructions may also cause communications data and credentials to be sent to the subscriber address at the communication service platform. The communications data may include a message and the credentials corresponding the subscriber account. The communication service platform may include a second processor in functional communication with a second memory. The second memory may store instructions that are executable by the second processor to publish the message to the subscriber account corresponding to the communication channel using the credentials, and push the message to other subscriber accounts in functional communication with the subscriber account.

In further embodiments, a computer-implemented method may send a notice to a plurality of subscribers. The method may set a communication channel for a portable computing device in response to receiving an activation input from an activation button of the portable computing device. The communication channel may correspond to a subscriber address of a subscriber account stored at a communication service platform that is remote from the portable computing device. The method may also cause communications data and credentials to be sent to the subscriber address at the communication service platform. The communications data may include a message and the credentials may correspond to the subscriber account. Too, the method may cause the communication service platform to publish the message to the subscriber account corresponding to the communication channel using the credentials, and cause the communication service platform to publish the message to other subscriber accounts in functional communication with the subscriber account.

### BRIEF DESCRIPTION OF THE DRAWINGS

FIG. 1 illustrates one embodiment of a notification system as described herein;

FIG. 1A illustrates another embodiment of the notification system as described herein;

FIG. 2 illustrates one embodiment of an example computing device to implement the processes for the notification system and method as described herein;

FIG. 3 illustrates one embodiment of an example flow diagram for a primary process for the notification system and method as described herein;

FIGS. 4A, 4B, 4C, 4D, and 4E illustrate embodiments of feedback and display state for the example computing device when implementing the processes for the notification system and method as described herein; and

FIG. 5 illustrates an embodiment of a computing device for use with the system and method as described herein.

The figures depict a preferred embodiment for purposes of illustration only. One skilled in the art may readily recognize from the following discussion that alternative embodiments of the structures and methods illustrated herein may be employed without departing from the principles described herein.

### DETAILED DESCRIPTION

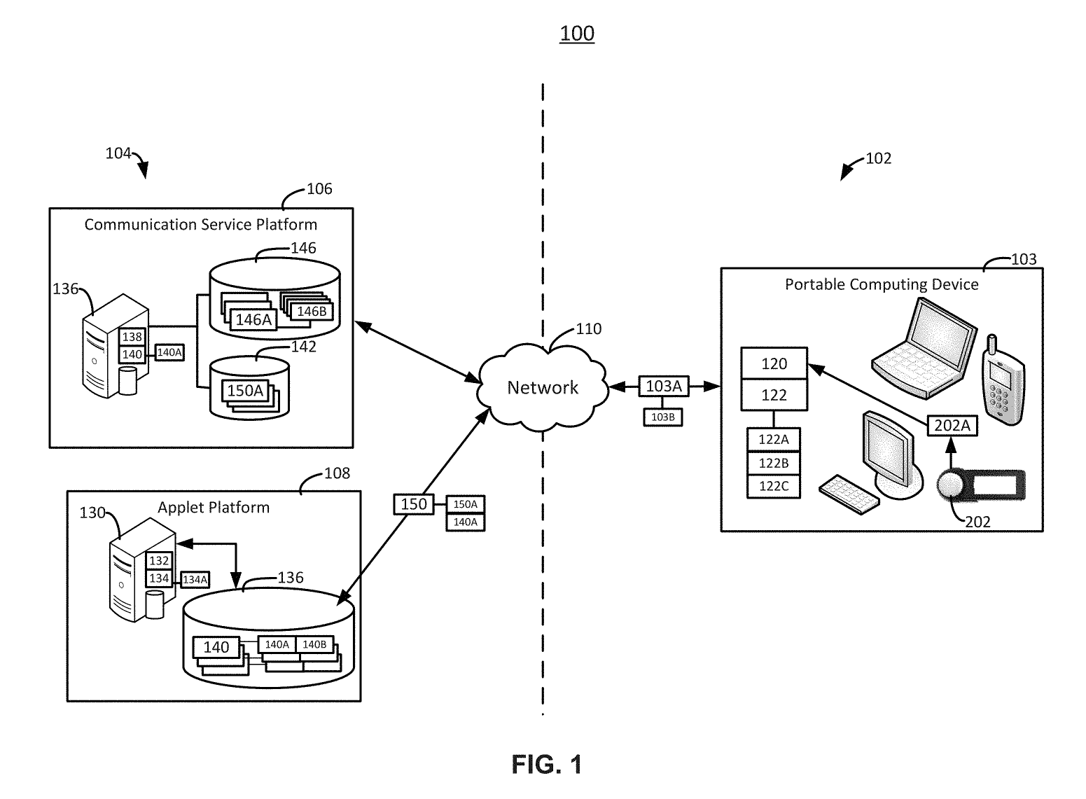

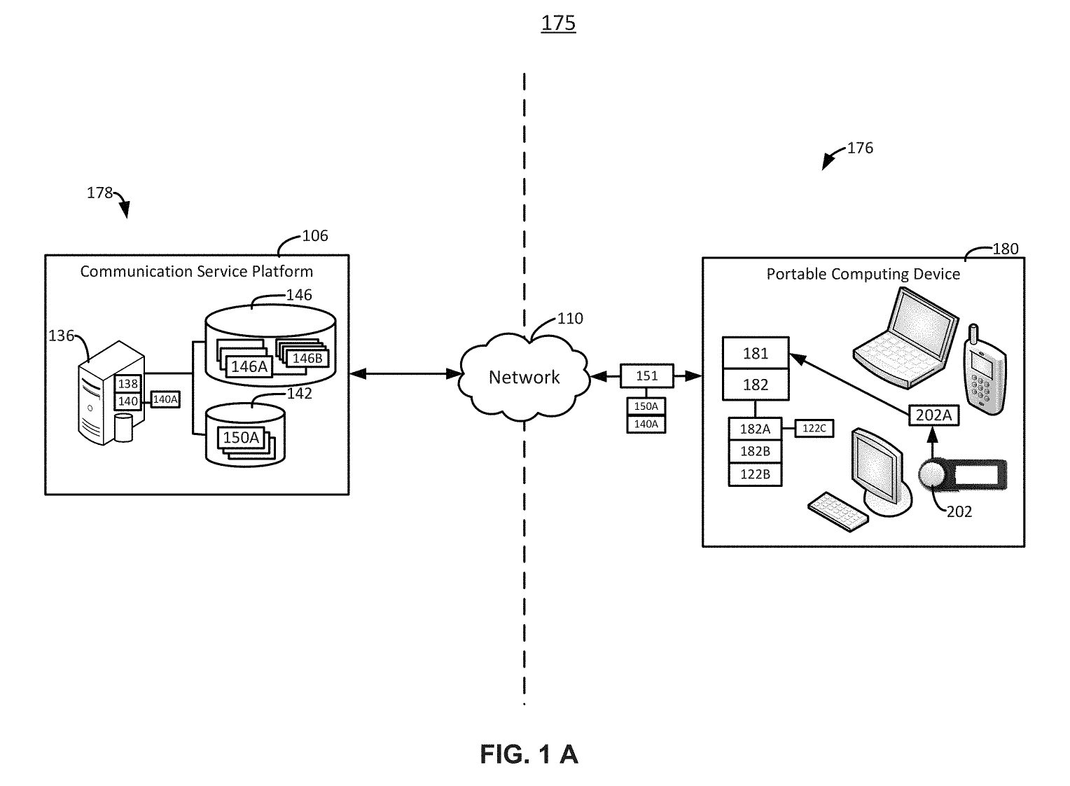

FIG. 1 generally illustrates one embodiment of a notification system 100 as described herein. The system 100 may include front end components 102 (e.g., a portable device 103 such as an open source electronics platform that is based on simple hardware and software). In some embodiments, the portable device 103 may include an Arduino board and associated components as herein described. The system 100 may also include backend components 104 (e.g., a communication service platform 106, an applet platform 108, etc.). The front end components 102 and backend components 104 may be in communication with each other via a communication link 110 (e.g., computer network, internet connection, etc.). The system 100 may include various software or computer-executable instructions and unique hardware components or modules that may employ the software and instructions to manage notifying users of an event as described herein. The various modules may be implemented as computer-readable storage memories containing computer-readable instructions (i.e., software) for execution by a processor of the computer system 100 within a specialized or unique computing device. The modules may perform the various tasks associated with notifying users as described herein. The computer system 100 may also include both hardware and software applications, as well as various data communications components for communicating data between the various specialized or unique front end 102 and back end 104 hardware and software components.

The portable computing device 103 may include a processor 120 and a memory 122. The memory may include one or more instruction modules 122A having computer-executable instructions that, when executed by the processor 120, cause the portable computing device 103 to functionally communicate with the other components (e.g., the applet platform 108, the communication service platform 106, etc.) of the system 100. The instruction modules 122A may include any computer-executable instructions to cause the portable computing system 103 and other components of the system 100 to execute any of the methods as described herein.

In some embodiments, the applet platform 108 may be in functional communication with other components of the system 100 (e.g., the portable computing device 103, the communication service platform 106, etc.). The applet platform 108 may include a server 130, a processor 132 and a memory 134. The server 130 may be in functional communication with an instruction set mass storage system 136 including one or more instruction sets 140. In some embodiments, the instruction sets 140 may include chains of conditional statements (e.g., applets) that depend on changes within devices such as the portable computing device 103 or external web services such as the communication service platform 106. The memory 134 may include an applet platform module 134A including instructions for executing the one or more instruction sets 140 using the processor 132. In some embodiments, the applet platform includes the IFTTT® service owned by IFTTT Inc. of San Francisco, Calif.

The communication service platform 106 may be in functional communication with other components of the system 100 (e.g., the applet platform 108, the portable computing device 103, etc.). The communication applet platform 106 may include a server 136 having a processor 138 and a memory 141. The memory 141 may store a communication service module 141A that includes computer-executable instructions to receive a request 150 from the applet platform 108 in response to a conditional statement being satisfied by the portable computing device 103, publish communications data 150A of the request 150 to account holders via the network 110 using a subscriber account 146A from a subscriber data mass storage system 146, and store the communications data 150A to a communications mass storage system 142. Each subscriber account 146A, 146B may be in functional communication with one or more other subscriber accounts 146A, 146B (e.g., first and second subscriber accounts, respectively). In some embodiments, the communication service platform includes the Twitter® service owned by Twitter, Inc. of San Francisco, Calif.

FIG. 1A generally illustrates another embodiment of a notification system 175 as described herein. The system 175 may include front end components 176 (e.g., an applet-enabled portable computing device 180) and backend components 178 (e.g., the communication service platform 106). The front end components 176 and backend components 178 may be in communication with each other via the communication link 110. The system 175 may include various software or computer-executable instructions and unique hardware components or modules that may employ the software and instructions to manage notifying users of an event as described herein. The various modules may be implemented as computer-readable storage memories containing computer-readable instructions (i.e., software) for execution by a processor of the computer system 175 within a specialized or unique computing device. The modules may perform the various tasks associated with notifying users as described herein. The computer system 175 may also include both hardware and software applications, as well as various data communications components for communicating data between the various specialized or unique front end 176 and back end 178 hardware and software components.

The applet-enabled portable computing device 180 may include a processor 181 and a memory 182. The memory may include one or more instruction modules 182A, 182B having computer-executable instructions that, when executed by the processor 181, cause the applet-enabled portable computing device 103 to functionally communicate with the communication service platform 106 of the system 175. The instruction modules 182A, 182B may include any computer-executable instructions to cause the portable computing system 180 and other components of the system 175 to execute any of the methods as described herein. In one embodiment, the instruction module 182A may include chains of conditional statements (e.g., an applet) that depend on changes within the applet-enabled portable computing device 175 or external web services such as the communication service platform 106.

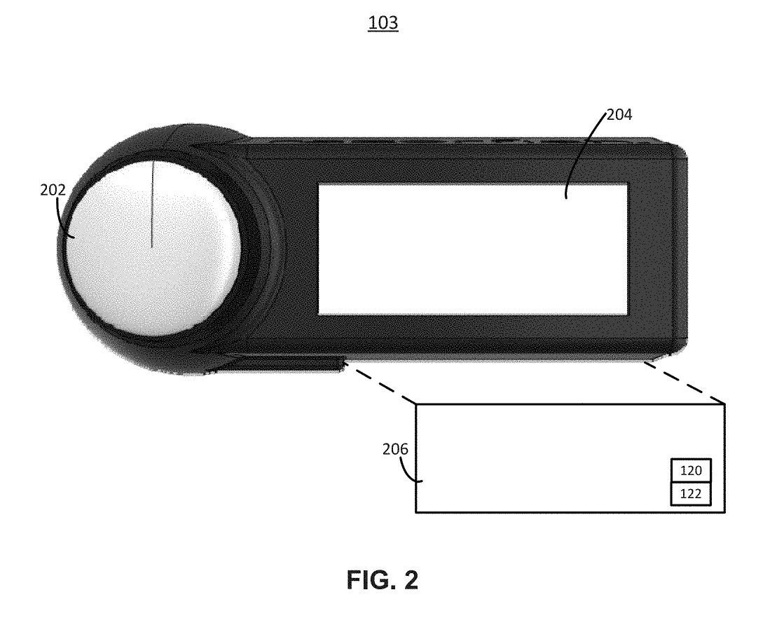

With reference to FIG. 2, the portable computing device 103 or the applet-enabled portable computing device 180 may include an activation button 202 (e.g., an RGB LED-backed arcade button or similar) and a display 204 (e.g., an LCD screen, etc.) in functional communication with an electronics platform 206 (e.g., an ARDUINO® board, smart phone, or similar). The electronics platform 206 may include the processor 120 or 181 and memory 122 or 182 with instruction modules 122A or 182A as well as sets of digital and analog input/output (I/O) pins that may be interfaced to various expansion boards (shields) and other circuits (e.g., the button 202, the display 204, etc.). The electronics platform 206 may also include serial communications interfaces, including Universal Serial Bus (USB), which may be used for loading one or more instruction modules (e.g., instruction modules 122A or 182A) from a personal computer or other computing device. The processor 120 or 181 may be programmed using a dialect of features from common programming languages (e.g., C, C++, etc.). In addition to using traditional compiler toolchains, the electronics platform 206 may be compatible with an integrated development environment (IDE).

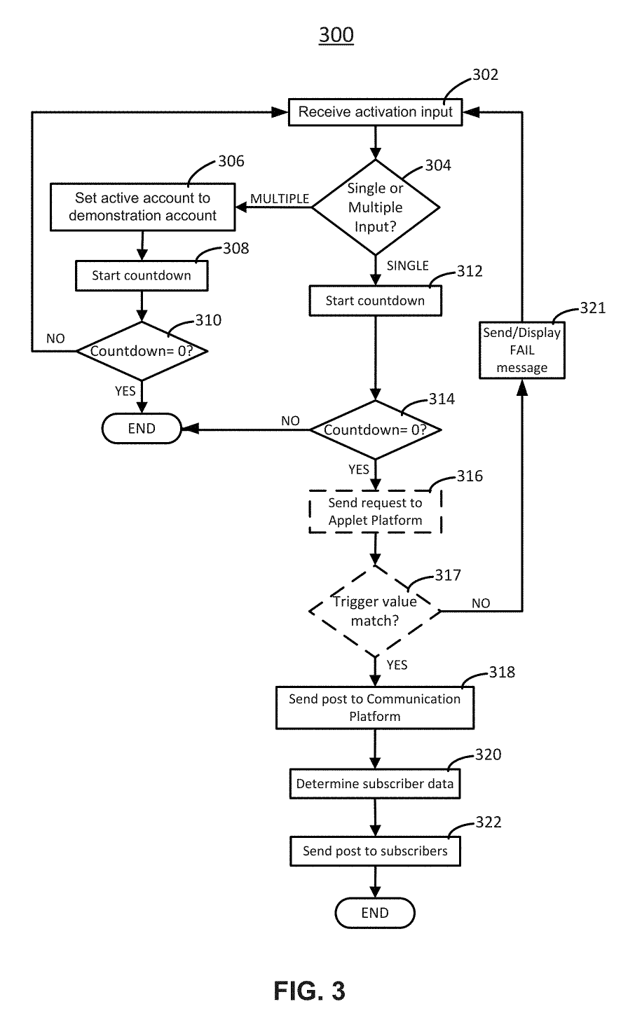

With reference to FIG. 3, the system 100 and/or the system 175, generally, and processors 120, 132, 138, 131, and 181 described herein may execute a method 300 to send a message to a subscriber account 146A, 146B of the communication service platform. In some embodiments, the message may indicate food availability in a particular area of the portable computing device 103 or applet-enabled portable computing device 180 or other notification. Each various “step” described herein may correspond to one or more computer-executable instructions of the modules 122A, 134A, 140A of the system 100 (FIG. 1) as executed on one or more processors such as processors 120, 132, and 138, and/or the modules 140A and 182A of the system 175 (FIG. 1A) as executed on one or more processors 181 and 138.

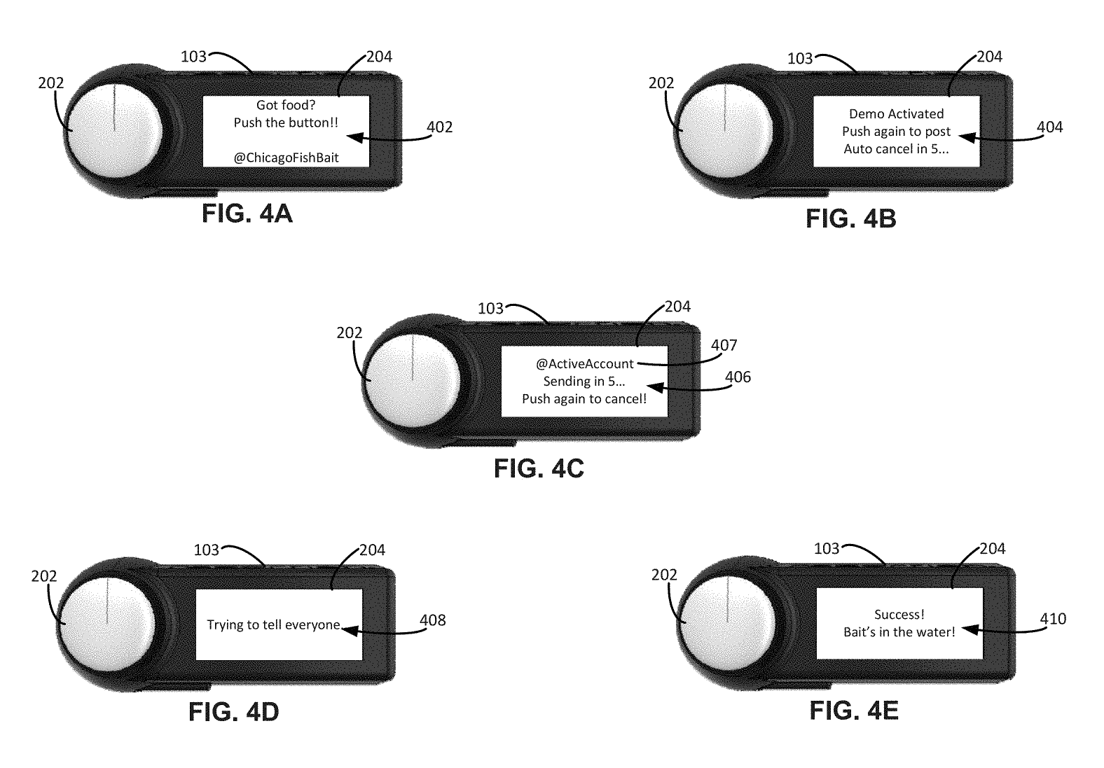

At block 302, the method 300 may send an activation input 202A (FIG. 1) from the activation button 202 to the processor 120, 181 in response to depressing the activation button. Receiving the activation input 202A at the processor 120, 181 may cause the processor to execute an instruction causing the portable computing device 103 or the applet-enabled portable computing device 180 to enter a different state. In some embodiments, step 302 may include allowing the processors 120, 181 to receive the activation input 202A from the activation button 202. With brief reference to FIG. 4A, the display 204 may include a welcome message 402 including instructions for the user at block 302. Where the method 300 employs the system 100, the activation input 202A may be a signal or other indication from the processors 120 of the portable computing device 103 to the applet platform 108. Where the method 300 employs the system 175, the activation input 202A may be a signal or other indication to the processor 181 of the applet-enabled portable computing device 180 to satisfy a conditional statement of the instruction module 182A.

The activation button 202 may send a signal or activation input 202A to the processor 120, 181 upon depressing the activation button 202 one or more times. In some embodiments, depressing the activation button 202 a number of times may cause the portable computing device 103 or applet-enabled portable computing device 180 to execute instructions to enter a different state, e.g., a warning state or a demonstration state, responsive to the inputs from the activation button 202. For example, a double click of the activation button 202 may send two activation inputs 202A to the processor 120, 181. In turn, the two activation inputs 202A may cause the portable computing device 103 or the applet-enabled portable computing device 180 to enter the demonstration state and display a demonstration message 404 (FIG. 4B). Similarly, a single click of the activation button 202 may send one activation input 202A to the processor 120, 181 and cause the portable computing device 103 or the applet-enabled portable computing device 180 to enter a warning state.

At block 304, the method 300 may determine whether the activation input 202A received by the processor 120 or 181 is a single click or multiple clicks of the activation button 202. Whether a single input or multiple inputs, responsive to the activation input 202A, the method 300 may cause the processor 120 or 181 to set a communication channel 122C (FIG. 1) of the portable computing device 103 to a particular subscriber address (e.g., subscriber address 407 of FIG. 4C) of a subscriber account 146A within the subscriber data mass storage system 146 of the communication service platform 106. For example, at block 306, the method 300 may cause the processor to execute an instruction to set the communication channel 122C to the subscriber account 146A indicating a demonstration account when the processor 120 or 181 receives multiple activation inputs 202A at block 304. With brief reference to FIG. 4B, receiving multiple activation inputs 202A may cause the display 204 to include a demonstration message 404 including instructions for the user. At block 308, the method 300 may cause the processor 120 to execute an instruction to start a countdown timer 122B at a predetermined number greater than zero. In some embodiments, the countdown timer may begin at five seconds. At block 310, the method may cause the processor 120 or 181 to execute an instruction to determine if the countdown timer 122B has reached zero. If the processor 120 or 181 receives further activation inputs 202A before the countdown timer 122B reaches zero, the method may return to block 302. If the countdown timer 122B does reach zero without the processor 120 or 181 receiving further activation input 202A, the method 300 may end.

Returning to block 304, when the processor 120 or 181 receives a single activation input 202A, the method 300 may cause the processor 120 or 181 to execute an instruction to start the countdown timer 122B at block 312. With brief reference to FIG. 4C, receiving a single activation input 202A may cause the display 204 to include a warning message 406 including instructions for the user. If the processor 120 receives an indication that the countdown timer 202 did not reach zero (e.g., the processor 120 receives another activation input 202A), the method 300 may end. If the processor 120 or 181 receives an indication that the countdown timer 202 reached zero (e.g., the processor 120 or 181 does not receive another activation input 202A), the processor 120 or 181 may cause the display 204 to include a “trying” message 408 (FIG. 4D) and the method 300 may proceed to block 316. Where the method 300 executes on the system 175, the method may proceed to block 318.

At block 316, where the method 300 executes on the system 100, the processor 120 may send request data 103A (FIG. 1) to the applet platform 108. Where the method employs the system 100, the request data 103A includes an indication for an instruction set 140. For example, the request data 103A may include a URL, such as a hash key encoded URL, that includes a request trigger value 103B such as: https://maker.ifttt.com/trigger/{trigger_value}/with/key/omhQIG4EzxcHf6MMhNMhGP4eLPbzIJjN3L2xX7 Where “{trigger_value}” may be replaced with:
Food%20in%20the%20Main%20Kitchen
   or another value that, when displayed, may communicate a message to the reader (e.g., “Food in the Main Kitchen”). In some embodiments, the trigger value 103B may be displayed via an HTML interpreter. The method 300 may send the request data 103A to an application programming interface (API) of the applet platform 108. Where the applet platform 108 includes IFTTT®, the method 300 may send the request data 103A to an IFTTT API. The method 300 may also set values for various objects (e.g., variables, functions, data structures, etc.) at block 316. For example, where JavaScript Object Notation (JSON) is used in the instruction set 140, the processor 120 may set values for JSON objects at block 316. Whether employing the system 100 or the system 175, block 316 may also pass other parameters to the API or directly to the communication service platform 106 such as a time stamp, other information pertaining to the request trigger value 103B (e.g., a type of food available, an identifier for a particular user sending the message to the applet platform 103 or the communication service platform 106, etc.).

At block 317, where the method 300 executes on the system 100, the method 300 may cause the processor 132 of the applet platform 108 to execute an instruction to determine if the request trigger value 103B matches an applet trigger value 140B. Where the request trigger value 103B matches the applet trigger value 140B, the method 300 may proceed to block 318. At block 321, where the request trigger value 103B does not match the applet trigger value 140B, the method 300 may cause the processor 132 of the applet platform 108 to send a fail message to the portable computing device 103. The processor 120 of the portable computing device may then execute an instruction to display the fail message (e.g., within the display 204) and cause the method 300 to end or the portable computing device 103 may execute an instruction to enter a “ready” state to receive further input, as in block 302. Where the request trigger value 103B matches the applet trigger value 140B, the method 300 may proceed to block 318.

At block 318, where the method 300 executes on the system 100, the processor 132 of the applet platform 318 may execute an instruction to send the request 150 including communications data 150A to the communications platform 106. In some embodiments, the processor 132 of the applet platform server 130 may load an instruction set 140 identified within the request data 103A to the memory 134 and execute the instruction set 140 using the communications data 150A or other data. The communications data 150A may include values passed to the applet platform 108 by the request data 103A (e.g., the request trigger value 103B, data values, etc.). Further, the instruction set 140 or other data within the instruction set mass storage system 136 may include credentials 140A corresponding to one or more subscriber accounts 146A from the subscriber data mass storage system 146 at the communication service platform 106. In some embodiments, the credentials 140A may permit access to the subscriber account 146A and publication of the communications data 150A via the subscriber accounts 146A, 146B. Block 318 may also include instructions to encrypt the request 150 and credentials 140A before sending it to the communication service platform 106, as described below in connection with the system 175.

At block 318, where the method 300 executes on the system 175 (FIG. 1A), the processor 181 of the applet-enabled portable computing device 180 may execute an instruction to send an encrypted request 151 including communications data 150A to the communications platform 106. In some embodiments, the processor 181 of the applet-enabled portable computing device 180 may load instructions of the instruction module 182A to the memory 182 and execute the instruction module 182A. The instructions may include incorporating various data into the request 151 and sending it to the communications platform 106. For example, the request may include data indicating the communication channel 122C as set at block 304, the communications data 150A, the credentials 140A, a UNIX time stamp and a random string, or other data. In some embodiments, the instructions may also include encrypting the request 151. For example, the instruction module 182A may cause the processor 181 to load an encryption module 1828 into memory 182. The processor 181 may then use the encryption module 1828 to encrypt the request 150. The encryption module 1828 may include instructions to employ a keyed-hash message authentication code (HMAC) including a cryptographic hash function (e.g., MD5, SHA-1, etc.) and a secret cryptographic key. The encryption module 1828 may also include instructions to simultaneously verify both the data integrity and the authentication of the request 150. Encrypting may be performed on the request before the request 150 is sent to the communication service platform 106. The communications data 150A may include values passed to the communication service platform 106 by the encrypted request 151 (e.g., the request trigger value 103B, data values, etc.) The encrypted request 151 may also include credentials 140A corresponding to one or more subscriber accounts 146A, 146B from the subscriber data mass storage system 146 at the communication service platform 106. The credentials 140A within the encrypted request 151 may permit access to a subscriber account 146A, 146B and publication of the request trigger value 103B or massage via the subscriber accounts 146A, 146B.

At block 320, responsive to receiving the request 150, the communication service platform 106 may execute an instruction to publish the communications data 150A. In some embodiments, the processor 138 of the communication platform server 136 may load an instruction into the memory 140 in response to receiving the request 150 from the applet platform 108 and execute the instruction using one or more of the communications data 150A and the credentials 140A. For example, the processor 138 may execute an instruction to publish or add the request trigger value 103B to a subscriber account 146A corresponding to the received credentials 140A. Publishing or adding the request trigger value 103B to a subscriber account 146A corresponding to the received credentials 140A may cause the processor 138 to publish or push the communications data 150A generally and the request trigger value 103B in particular to other subscriber accounts 146A (e.g., 146B) that is in functional communication with the subscriber account 146A. Where the communication service platform 106 includes TWITTER®, the method 300 may send the communications data 150A and the credentials 140A to an API of the communication service platform 106. The method 300 may then publish the communications data 150A to a webpage corresponding to a first subscriber account 146A. That communications data 150A may then appear within a webpage or otherwise be communicated to other webpages or second subscriber account 146B corresponding to users who have subscribed to the first subscriber account 146A. With brief reference to FIG. 4E, executing block 320 may cause the display 204 of the portable computing device 103 to include a “success” message 410. After execution of block 320, the method 300 may end or the portable computing device 103 may execute an instruction to enter a “ready” state to receive further input, as in block 302.

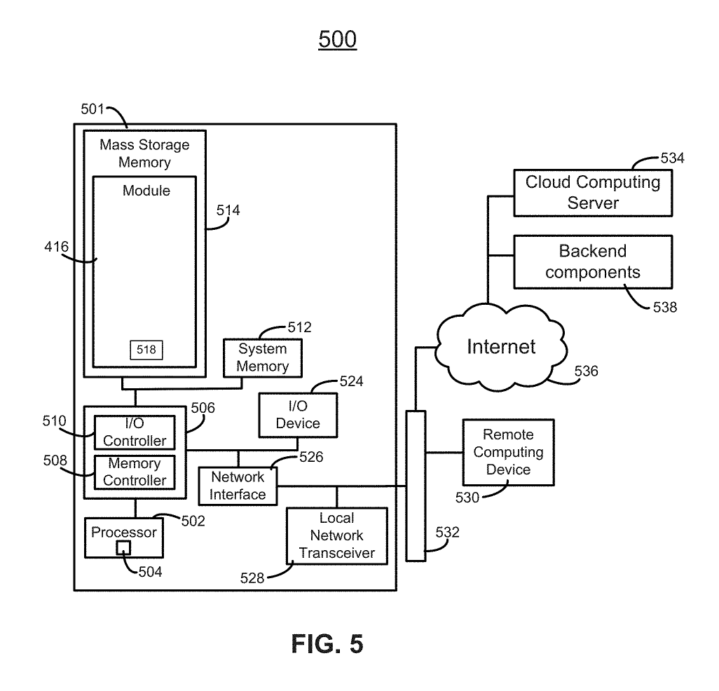

FIG. 5 is a high-level block diagram of an example computing environment 500 for the system 100 or the system 175 and method 300 for sending a message to a subscriber account of the communication service platform, as described herein. The computing device 501 may include a server (e.g., the server 130, 136, etc.), a computing device (e.g., portable computing device 103, applet-enabled portable computing device 180, etc.), a cellular phone, a tablet computer, a Wi-Fi-enabled device or other personal computing device capable of wireless or wired communication, a thin client, or other known type of computing device. As will be recognized by one skilled in the art, in light of the disclosure and teachings herein, other types of computing devices can be used that have different architectures. Processor systems similar or identical to the example systems and methods described herein may be used to implement and execute the example systems of FIG. 1 and FIG. 1A and method of FIG. 3. Although the example system 500 is described below as including a plurality of peripherals, interfaces, chips, memories, etc., one or more of those elements may be omitted from other example processor systems used to implement and execute the example systems and methods. Also, other components may be added.

As shown in FIG. 5, the computing device 500 includes a processor 502 that is coupled to an interconnection bus. The processor 502 includes a register set or register space 504, which is depicted in FIG. 5 as being entirely on-chip, but which could alternatively be located entirely or partially off-chip and directly coupled to the processor 502 via dedicated electrical connections and/or via the interconnection bus. The processor 502 may be any suitable processor, processing unit or microprocessor. Although not shown in FIG. 5, the computing device 501 may be a multi-processor device and, thus, may include one or more additional processors that are identical or similar to the processor 502 and that are communicatively coupled to the interconnection bus.

The processor 502 is coupled to a chipset 506, which includes a memory controller 508 and a peripheral input/output (I/O) controller 510. As is well known, a chipset typically provides I/O and memory management functions as well as a plurality of general purpose and/or special purpose registers, timers, etc. that are accessible or used by one or more processors coupled to the chipset 506. The memory controller 508 performs functions that enable the processor 502 (or processors if there are multiple processors) to access a system memory 512 and a mass storage memory 514, that may include either or both of an in-memory cache (e.g., a cache within the memory 512) or an on-disk cache (e.g., a cache within the mass storage memory 514).

The system memory 512 may include any desired type of volatile and/or non-volatile memory such as, for example, static random access memory (SRAM), dynamic random access memory (DRAM), flash memory, read-only memory (ROM), etc. The mass storage memory 514 may include any desired type of mass storage device. For example, the computing device 501 may be used to implement a module 516 (e.g., the various modules as herein described). The mass storage memory 514 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 501, the system 100, the system 175, and method 300. Thus, a module, block, function, operation, procedure, routine, step, and method can be implemented in hardware, firmware, and/or software. In one embodiment, program modules and routines are stored in mass storage memory 514, loaded into system memory 512, and executed by a processor 502 or can be provided from computer program products that are stored in tangible computer-readable storage mediums (e.g. RAM, hard disk, optical/magnetic media, etc.).

The peripheral I/O controller 510 performs functions that enable the processor 502 to communicate with a peripheral input/output (I/O) device 524, a network interface 526, a local network transceiver 528, (via the network interface 526) via a peripheral I/O bus. The I/O device 524 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O device 524 may be used with the module 516, etc., to receive data from the transceiver 528, send the data to the components of the system 100 and/or system 175, and perform any operations related to the method 300 as described herein. The local network transceiver 528 may include support for a Wi-Fi network, Bluetooth, Infrared, cellular, or other wireless data transmission protocols. In other embodiments, one element may simultaneously support each of the various wireless protocols employed by the computing device 501. For example, a software-defined radio may be able to support multiple protocols via downloadable instructions. In operation, the computing device 501 may be able to periodically poll for visible wireless network transmitters (both cellular and local network) on a periodic basis. Such polling may be possible even while normal wireless traffic is being supported on the computing device 501. The network interface 526 may be, for example, an Ethernet device, an asynchronous transfer mode (ATM) device, an 802.11 wireless interface device, a DSL modem, a cable modem, a cellular modem, etc., that enables the system 100 and/or system 175 to communicate with another computer system having at least the elements described in relation to the systems 100, 175.

While the memory controller 508 and the I/O controller 510 are depicted in FIG. 5 as separate functional blocks within the chipset 506, the functions performed by these blocks may be integrated within a single integrated circuit or may be implemented using two or more separate integrated circuits. The computing environment 500 may also implement the module 516 on a remote computing device 530. The remote computing device 530 may communicate with the computing device 501 over an Ethernet link 532. In some embodiments, the module 516 may be retrieved by the computing device 501 from a cloud computing server 534 via the Internet 536. When using the cloud computing server 534, the retrieved module 516 may be programmatically linked with the computing device 501. The module 516 may be a collection of various software platforms including artificial intelligence software and document creation software or may also be a Java® applet executing within a Java® Virtual Machine (JVM) environment resident in the computing device 501 or the remote computing device 530. The module 516 may also be a “plug-in” adapted to execute in a web-browser located on the computing devices 501 and 530. In some embodiments, the module 516 may communicate with back end components 538 via the Internet 536.

The system 500 may include but is not limited to any combination of a LAN, a MAN, a WAN, a mobile, a wired or wireless network, a private network, or a virtual private network. Moreover, while only one remote computing device 530 is illustrated in FIG. 5 to simplify and clarify the description, it is understood that any number of client computers are supported and can be in communication within the system 100 and/or the system 175.

Additionally, certain embodiments are described herein as including logic or a number of components, modules, or mechanisms. Modules may constitute either software modules (e.g., code or instructions embodied on a machine-readable medium or in a transmission signal, wherein the code is executed by a processor) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A portable computing device for sending a notice to a plurality of subscribers, the portable computing device comprising:
a first processor in functional communication with a first memory;
an activation button in functional communication with the first processor;
a display in functional communication with the first processor;
an instruction module stored in the first memory and including instructions that are executable by the first processor to:
send an activation input from the activation button to the first processor;
set a communication channel for the portable computing device in response to the activation input, the communication channel corresponding to a subscriber address of a subscriber account stored at a communication service platform that is remote from the portable computing device; and
cause communications data and credentials to be sent to the subscriber address at the communication service platform, the communications data including a message and the credentials corresponding the subscriber account;
wherein the communication service platform includes a second processor in functional communication with a second memory, the second memory storing instructions that are executable by the second processor to:
publish the message to the subscriber account corresponding to the communication channel using the credentials; and
push the message to other subscriber accounts in functional communication with the subscriber account.

2. The portable computing device of claim 1, wherein the message includes an indication of food availability and a location.

3. The portable computing device of claim 1, wherein the activation input satisfies a conditional statement of the instruction module.

4. The portable computing device of claim 1, wherein the instruction that is executable by the first processor to send the activation input from the activation button to the first processor includes an instruction to send the activation input from the activation button to the first processor in response to depressing the activation button.

5. The portable computing device of claim 1, wherein the activation input includes either a single activation input or multiple activation inputs.

6. The portable computing device of claim 5, wherein the single activation input causes the first processor to execute an instruction of the instruction module to enter a warning state.

7. The portable computing device of claim 5, wherein the multiple activation input causes the first processor to execute an instruction of the instruction module to enter a demonstration state and to display a demonstration message within the display.

8. The portable computing device of claim 1, further comprising a countdown timer stored in the first memory and including instructions that are executable by the first processor to start counting down from a predetermined number greater than zero responsive to executing the instruction to send the activation input from the activation button to the first processor.

9. The portable computing device of claim 1, wherein the instruction to cause communications data and credentials to be sent to the subscriber address at the communication service platform includes an instruction to send request data to an applet platform that is remote from the portable computing device, wherein the request data includes a trigger value for an instruction set stored at the applet platform.

10. The portable computing device of claim 9, wherein the instruction to cause communications data and credentials to be sent to the subscriber address at the communication service platform includes the applet platform executing the instruction set using a third processor in functional communication with a third memory, the instruction set including an instruction to use the trigger value to send communications data and credentials to the subscriber address at the communication service platform.

11. The portable computing device of claim 1, further including an encryption module stored in the first memory and including instructions that are executable by the first processor to encrypt the communications data and the credentials before the first processor executes instructions to cause the communications data and the credentials to be sent to the subscriber address at the communication service platform.

12. A computer-implemented method for sending a notice to a plurality of subscribers, the method comprising:
setting a communication channel for a portable computing device in response to receiving an activation input from an activation button of the portable computing device, the communication channel corresponding to a subscriber address of a subscriber account stored at a communication service platform that is remote from the portable computing device;
causing communications data and credentials to be sent to the subscriber address at the communication service platform, the communications data including a message and the credentials corresponding to the subscriber account;
causing the communication service platform publish the message to the subscriber account corresponding to the communication channel using the credentials; and
causing the communication service platform to publish the message to other subscriber accounts in functional communication with the subscriber account.

13. The computer-implemented method of claim 12, wherein the message includes an indication of food availability and a location.

14. The computer-implemented method of claim 12, wherein setting the communication channel for the portable computing device in response to receiving the activation input from the activation button of the portable computing device is responsive to depressing the activation button.

15. The computer-implemented method of claim 12, wherein the activation input includes either a single activation input or multiple activation inputs.

16. The computer-implemented method of claim 15, wherein, responsive to the single activation input, the portable computing device enters a warning state.

17. The computer-implemented method of claim 15, wherein, responsive to the multiple activation input, the portable computing device enters a demonstration state and displays a demonstration message within a display of the portable computing device.

18. The computer-implemented method of claim 12, further comprising, responsive to receiving the activation input from the activation button of the portable computing device, counting down from a predetermined number greater than zero.

19. The computer-implemented method of claim 12, wherein:
causing communications data and credentials to be sent to the subscriber address at the communication service platform includes sending request data to an applet platform that is remote from the portable computing device, wherein the request data includes a trigger value for an instruction set stored at the applet platform, and
causing communications data and credentials to be sent to the subscriber address at the communication service platform includes using the trigger value to send communications data and credentials to the subscriber address at the communication service platform.

20. The computer-implemented method of claim 12, further comprising encrypting the communications data and the credentials before causing the communications data and the credentials to be sent to the subscriber address at the communication service platform.
